(19) United States
(12) Patent Application Publication
(10) Pub. No.: US 2018/0107988 A1
(43) Pub. Date: Apr. 19, 2018

(54) Estimating the Number of Attendees in a Meeting

(71) Applicant: International Business Machines Corporation, Armonk, NY (US)

(72) Inventors: Noel C. Codella, White Plains, NY (US); Jonathan Lenchner, North Salem, NY (US)

(21) Appl. No.: 15/295,409

(22) Filed: Oct. 17, 2016

(51) Int. Cl. G06Q 10/10; G06N 99/00; G06Q 10/06

(52) U.S. Cl. CPC G06Q 10/1095; G06Q 10/06313; G06N 99/005

(57) ABSTRACT

Methods, systems, and computer program products for estimating the number of attendees in a meeting are provided herein. A computer-implemented method includes generating one or more event attendance models for individuals, wherein said generating comprises applying one or more machine learning techniques to a set of training data; computing a probability that each of the individuals will attend a given event by applying one or more of the generated attendance models to (i) an invitation for the given event and (ii) a communication attributed to each of the individuals in response to the invitation; estimating the number of the individuals that will attend the given event by combining the computed probabilities; and outputting the estimated number of the individuals that will attend the given event to at least one user.

### FIELD

The present application generally relates to information technology, and, more particularly, to enterprise management technologies.

### BACKGROUND

Consider a scenario wherein people are invited to a meeting, a conference, a talk, etc., and wherein the meeting/conference room in which the event is to take place has a given, limited seating capacity. Commonly, the organizer of the event overestimates the number of attendees so as to arrange or book a meeting/conference room that is larger than is likely necessary for the event. However, if fewer people than anticipated ultimately attend the event, the spatial dynamics of a sparsely populated room can create awkwardness as well as potential logistical problems. Additionally, such an attendee turnout can preclude a more appropriately-sized event to make use of the room, thereby creating allocation efficiency problems.

### SUMMARY

In one embodiment of the present invention, techniques for estimating the number of attendees in a meeting are provided. An exemplary computer-implemented method can include steps of generating one or more event attendance models for individuals, wherein generating comprises applying one or more machine learning techniques to a set of training data, and computing a probability that each of the individuals will attend a given event by applying one or more of the generated attendance models to (i) an invitation for the given event and (ii) a communication attributed to each of the individuals in response to the invitation. Such a method can also include estimating the number of the individuals that will attend the given event by combining the computed probabilities, and outputting the estimated number of the individuals that will attend the given event to at least one user.

Another embodiment of the invention or elements thereof can be implemented in the form of a computer program product tangibly embodying computer readable instructions which, when implemented, cause a computer to carry out a plurality of method steps, as described herein. Furthermore, another embodiment of the invention or elements thereof can be implemented in the form of a system including a memory and at least one processor that is coupled to the memory and configured to perform noted method steps.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating a system architecture, according to an embodiment of the invention;

FIG. 2 is a flow diagram illustrating techniques according to an embodiment of the invention;

FIG. 3 is a computer system, according to an embodiment of the invention;

FIG. 4 depicts a cloud computing environment according to an embodiment of the invention; and

FIG. 5 depicts abstraction model layers according to an embodiment of the invention.

### DETAILED DESCRIPTION

As described herein, an embodiment of the present invention includes estimating the number of attendees in a meeting via machine learning techniques. At least one embodiment of the invention includes generating an estimate of the number of attendees for a meeting or event based on the number of individuals invited to the meeting, the invitation responses of those individuals (for example, attending, not attending, tentative, no response, etc.), and an estimated likelihood of attending attributed to each of the individuals, given the invitation response of each individual. Based on the generated estimate of attendees, the meeting coordinator or organizer can allocate related resources such as, for example, booking and/or arranging a room of an appropriate size for the event.

Illustrative embodiments of the present invention will be described herein with reference to exemplary computer networks and associated computers, servers, network devices or other types of processing devices. It is to be appreciated, however, that the invention is not restricted to use with the particular illustrative network and device configurations shown. Accordingly, the term “computer network” as used herein is intended to be broadly construed, so as to encompass, for example, any system comprising multiple networked processing devices.

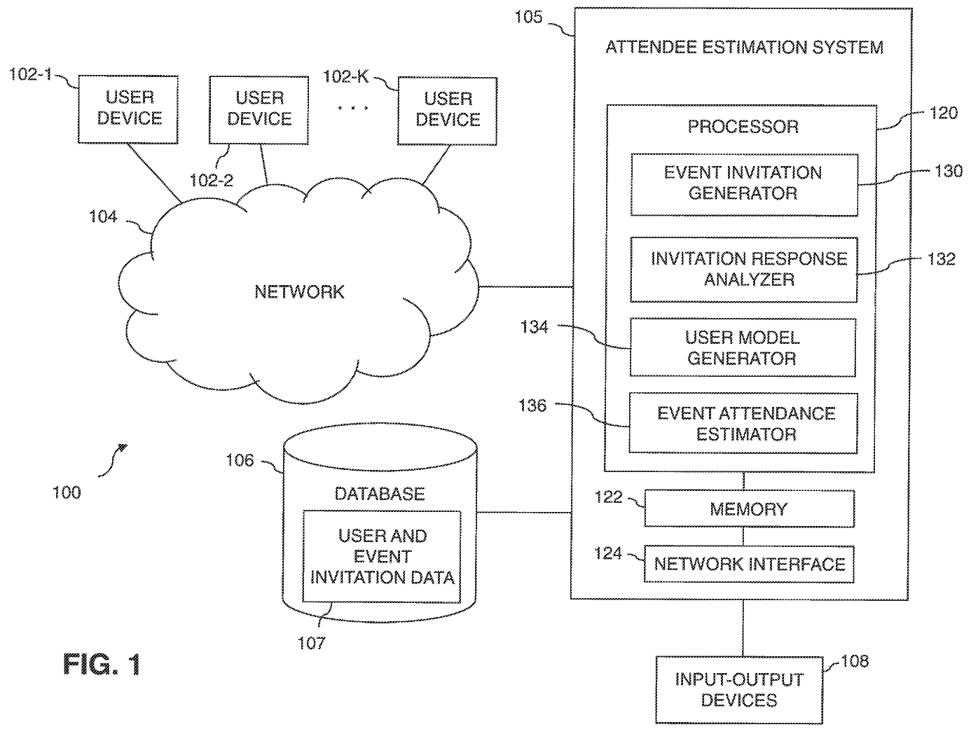

FIG. 1 depicts an example of a computer network 100 configured in accordance with an illustrative embodiment of the invention. As depicted, computer network 100 comprises a plurality of user devices 102-1, 102-2, . . . 102-K, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to the network 104 is an attendee estimation system 105.

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including but not limited to a wide area network (WAN), a local area network (LAN), a satellite network, a telephone or cable network, a cellular network, a wireless network such as a Wi-Fi or WiMAX network, or various portions or combinations of these and other types of networks. By way of further example only, the computer network 100 in some embodiments can comprise combinations of multiple different types of networks each comprising processing devices configured to communicate using internet protocol (IP) or other known communication protocols.

In this example, the attendee estimation system 105 is communicatively coupled to database 106, which is configured to store user and event invitation data 107. The database 106 in the present embodiment is implemented using one or more storage systems associated with the attendee estimation system 105. Such storage systems can comprise any of a variety of different types of storage, including but not limited to network-attached storage (NAS), storage area networks (SANS), direct-attached storage (DAS) and distributed DAS, as well as combinations of these and other storage types, including software-defined storage.

Also associated with the attendee estimation system 105 are input-output devices 108, which illustratively comprise keyboards, displays or other types of input-output devices in any combination. Such input-output devices are used to support one or more user interfaces of the attendee estimation system 105, as well as to support communication between the attendee estimation system 105 and other related systems and devices not explicitly shown.

The attendee estimation system 105 in the FIG. 1 embodiment is assumed to be implemented using at least one processing device. Each such processing device generally comprises at least one processor and an associated memory, and implements one or more functional modules for controlling certain features of the attendee estimation system 105.

More particularly, the attendee estimation system 105 in this embodiment comprises a processor 120 communicatively coupled to a memory 122 and a network interface 124. In some embodiments, the processor 120 comprises a microprocessor, a microcontroller, an application-specific integrated circuit (ASIC), a field-programmable gate array (FPGA) or other type of processing elements, as well as portions or combinations of such elements. In some embodiments, the memory 122 comprises volatile and/or non-volatile memory, such as random access memory (RAM), read-only memory (ROM) or other types of memory, in any combination. Memory 122, other memories and other storage devices may be viewed as examples of what are sometimes referred to as “computer-readable storage media” storing one or more executable computer programs, instructions, code, and other executables.

One or more embodiments of the invention include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals.

Referring again to the example depicted in FIG. 1, an interface 124 may comprise one or more conventional transceivers (not depicted) and facilitate attendee estimation system 105 to communicate locally with one or more input-output devices 108 and remotely (over the network 104) with one or more user devices 102. The processor 120 further comprises an event invitation generator 130, an invitation response analyzer 132, a user model generator 134 and an event attendance estimator 136. It is to be appreciated that the particular arrangement of modules 130, 132, 134 and 136 illustrated in the processor 120 of FIG. 1 is presented by way of example only, and alternative arrangements can be used. For example, the functionality associated with the modules 130, 132, 134 and 136 can be combined into a single module, or separated across a larger number of modules. As another example, multiple distinct processors can be used to implement different ones of the modules 130, 132, 134 and 136 or portions thereof.

At least portions of the event invitation generator 130, invitation response analyzer 132, user model generator 134 and event attendance estimator 136 may be implemented at least in part in the form of software that is stored in an article of manufacture (such as memory 122) and executed by processor 120.

It is to be understood that other embodiments may include fewer, additional or alternative systems, devices and other network entities, as well as different arrangements of modules and other components. By way of example only, in other embodiments, the attendee estimation system 105 can be eliminated and associated elements such as event invitation generator 130, invitation response analyzer 132, user model generator 134 and event attendance estimator 136 can be implemented elsewhere in the computer network 100.

One or more exemplary processes utilizing event invitation generator 130, invitation response analyzer 132, user model generator 134 and event attendance estimator 136 of the attendee estimation system 105 in computer network 100 will be described in more detail below.

At least one embodiment of the invention includes creating a predictive model (via user model generator 134) for each individual. Such a model can subsequently be used by the event attendance estimator 136 to estimate the likelihood that the given individual will attend a particular meeting, given the invitation (generated by component 130) and the individual's response to the invitation (Yes/No/Maybe/No Response), as analyzed by component 132. The user model generator 134 can employ machine learning techniques to learn and generate such models from existing data, such as the user and event invitation data 107 stored within database 106. Further, the event attendance estimator 136 can use the models to estimate the number of meeting participants for a particular meeting.

User and event invitation data 107, stored within database 106, can include, for example, the subject matter of multiple meeting invitations, the scheduled day and time (repeating or not repeating) of multiple meeting invitations, the duration of multiple scheduled meetings, an identification of other invited participants for multiple meetings, and the name of invitees for multiple meetings. Additionally, data 107 can also include invitation responses from multiple individuals in connection with multiple meetings, as well as a confirmation (from a meeting coordinator, for example) as to whether multiple individuals did or did not attended particular meetings. Further, data 107 can also include relevant and/or publically-accessible information about multiple individuals (job title, etc.).

Using a collection of models (each corresponding to a distinct invitee to a particular meeting) generated by component 134 based on inputs from components 130 and 132, as well as the user and event invitation data 107, the event attendance estimator 136 generates an expected number of participants at the meeting by summing the estimated likelihood of each of the individual models.

Additionally, one or more embodiments of the invention can include an agent-based implementation. In such an embodiment, each user device with a calendar function or application resident thereon can further include an agent that continuously updates the likelihood that the corresponding user will attend one or more different meetings. Additionally, in such an embodiment, the agent can be built-in, implemented in the cloud, and effectively part of the application in use by the user. The updates to the likelihood assessments can be based on the agent obtaining and/or analyzing additional information related to the likelihood of the user's attendance. Such information might include, for example, a (newly) conflicting entry on the user's calendar, a calendar entry immediately following the scheduled meeting (for instance, an entry deemed as important, such as a meeting with the user's boss or a presentation), etc.

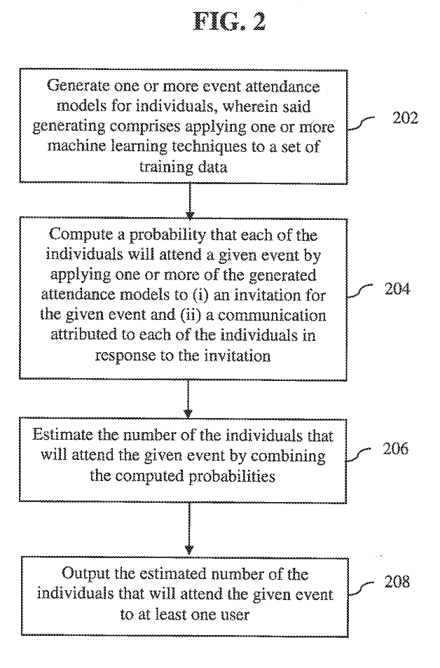

FIG. 2 is a flow diagram illustrating techniques according to an embodiment of the present invention. Step 202 includes generating one or more event attendance models for individuals, wherein said generating comprises applying one or more machine learning techniques to a set of training data. Generating event attendance models can include generating a separate event attendance model for each of the individuals, as well as generating an event attendance model that is applicable to two or more of the individuals.

The training data can include event invitation data associated with multiple events, such as the subject matter of the associated event, the scheduled day and time of the associated event, the duration of the associated event, and an identification of one or more of the invited individuals for the associated event. The training data can also include communications attributed to the individuals in response to invitations to one or more events, confirmation of event attendance for one or more previous events, as well as publically-available information regarding the individuals (such as job description, the location of an individual in an organization chart, title, publications, etc.).

Step 204 includes computing a probability that each of the individuals will attend a given event by applying one or more of the generated attendance models to (i) an invitation for the given event and (ii) a communication attributed to each of the individuals in response to the invitation. The communication attributed to each of the individuals in response to the invitation can include one of (i) an indication that the individual will attend the given event, (ii) an indication that the individual will not attend the given event, and (iii) an indication that the individual is uncertain about attending the given event.

Step 206 includes estimating the number of the individuals that will attend the given event by combining the computed probabilities. Step 208 includes outputting the estimated number of the individuals that will attend the given event to at least one user.

The techniques depicted in FIG. 2 can also include retrieving the one or more generated attendance models associated with the individuals invited to the given event based on an analysis of the invitation. Further, at least one embodiment of the invention can include allocating one or more resources to the given event based on the estimated number of the individuals that will attend the given event, wherein the one or more resources can include, for example, a venue of an appropriate size for holding the given event.

Also the techniques depicted in FIG. 2 can additionally include incorporating, into the estimated number of the individuals that will attend the given event, an estimated number of non-invited individuals that will attend the given event. Further, one or more embodiments of the invention can include revising the estimated number of the individuals that will attend the given event based on the number of reminder messages sent regarding the given event. Such revising can be further based, for example, on the proximity to the given event that the reminder messages are sent.

Also, the techniques depicted in FIG. 2 can include iteratively changing the scheduled time of the given event to generate multiple proposed scheduled times for the given event, and computing a probability that each of the individuals will attend the given event at each of the multiple proposed scheduled times by applying one or more of the generated attendance models to (i) the invitation for the given event and (ii) a communication attributed to each of the individuals in response to the invitation. Such an embodiment additionally includes estimating the number of the individuals that will attend the given event at each of the multiple proposed scheduled times by combining the computed probabilities, and outputting the proposed scheduled time corresponding to the highest estimated number of the individuals that will attend the given event to at least one user. In accordance with one or more embodiments of the invention, a component of an event invitation is the scheduled time of the event. Accordingly, such an embodiment can include iteratively changing the scheduled time, computing the predicted number of attendees for each time, and returning a time that maximizes the number of predicted attendees.

Additionally, in accordance with one or more embodiments of the invention, software that implements the techniques depicted in FIG. 2 can be provided as a service in a cloud environment.

The techniques depicted in FIG. 2 can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an embodiment of the invention, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 2 can be implemented via a computer program product that can include computer useable program code that is stored in a computer readable storage medium in a data processing system, and wherein the computer useable program code was downloaded over a network from a remote data processing system. Also, in an embodiment of the invention, the computer program product can include computer useable program code that is stored in a computer readable storage medium in a server data processing system, and wherein the computer useable program code is downloaded over a network to a remote data processing system for use in a computer readable storage medium with the remote system.

An embodiment of the invention or elements thereof can be implemented in the form of an apparatus including a memory and at least one processor that is coupled to the memory and configured to perform exemplary method steps.

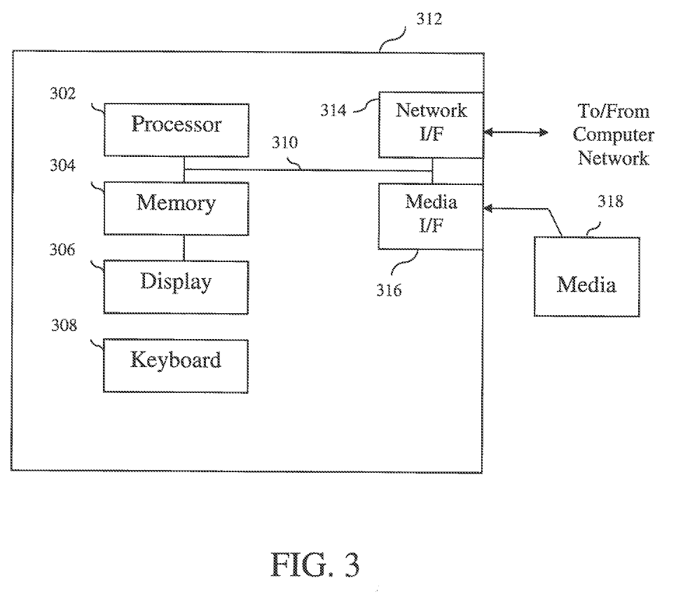

Additionally, an embodiment of the present invention can make use of software running on a computer or workstation. With reference to FIG. 3, such an implementation might employ, for example, a processor 302, a memory 304, and an input/output interface formed, for example, by a display 306 and a keyboard 308. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, a mechanism for inputting data to the processing unit (for example, mouse), and a mechanism for providing results associated with the processing unit (for example, printer). The processor 302, memory 304, and input/output interface such as display 306 and keyboard 308 can be interconnected, for example, via bus 310 as part of a data processing unit 312. Suitable interconnections, for example via bus 310, can also be provided to a network interface 314, such as a network card, which can be provided to interface with a computer network, and to a media interface 316, such as a diskette or CD-ROM drive, which can be provided to interface with media 318.

Accordingly, computer software including instructions or code for performing the methodologies of the invention, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 302 coupled directly or indirectly to memory elements 304 through a system bus 310. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including, but not limited to, keyboards 308, displays 306, pointing devices, and the like) can be coupled to the system either directly (such as via bus 310) or through intervening 110 controllers (omitted for clarity).

Network adapters such as network interface 314 may also be coupled to the system to enable the data processing system to become coupled to other data processing systems or remote printers or storage devices through intervening private or public networks. Modems, cable modems and Ethernet cards are just a few of the currently available types of network adapters.

As used herein, including the claims, a “server” includes a physical data processing system (for example, system 312 as shown in FIG. 3) running a server program. It will be understood that such a physical server may or may not include a display and keyboard.

The present invention may be a system, a method, and/or a computer program product at any possible technical detail level of integration. The computer program product may include a computer readable storage medium (or media) having computer readable program instructions thereon for causing a processor to carry out embodiments of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform embodiments of the present invention.

Embodiments of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It should be noted that any of the methods described herein can include an additional step of providing a system comprising distinct software modules embodied on a computer readable storage medium; the modules can include, for example, any or all of the components detailed herein. The method steps can then be carried out using the distinct software modules and/or sub-modules of the system, as described above, executing on a hardware processor 302. Further, a computer program product can include a computer-readable storage medium with code adapted to be implemented to carry out at least one method step described herein, including the provision of the system with the distinct software modules.

In any case, it should be understood that the components illustrated herein may be implemented in various forms of hardware, software, or combinations thereof, for example, application specific integrated circuit(s) (ASICS), functional circuitry, an appropriately programmed digital computer with associated memory, and the like. Given the teachings of the invention provided herein, one of ordinary skill in the related art will be able to contemplate other implementations of the components of the invention.

Additionally, it is understood in advance that implementation of the teachings recited herein are not limited to a particular computing environment. Rather, embodiments of the present invention are capable of being implemented in conjunction with any type of computing environment now known or later developed.

For example, cloud computing is a model of service delivery for enabling convenient, on-demand network access to a shared pool of configurable computing resources (for example, networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (for example, country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (for example, storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (for example, web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (for example, host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (for example, mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (for example, cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

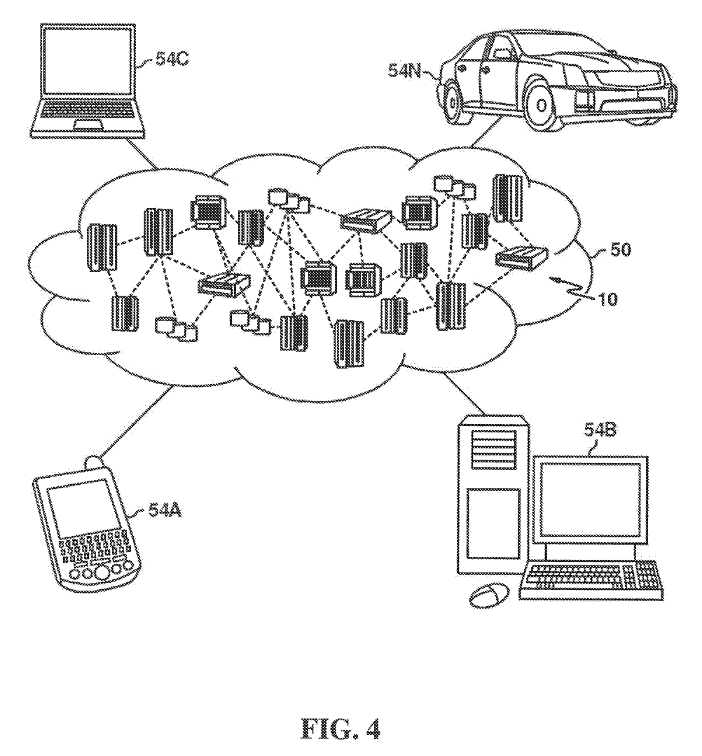

Referring now to FIG. 4, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

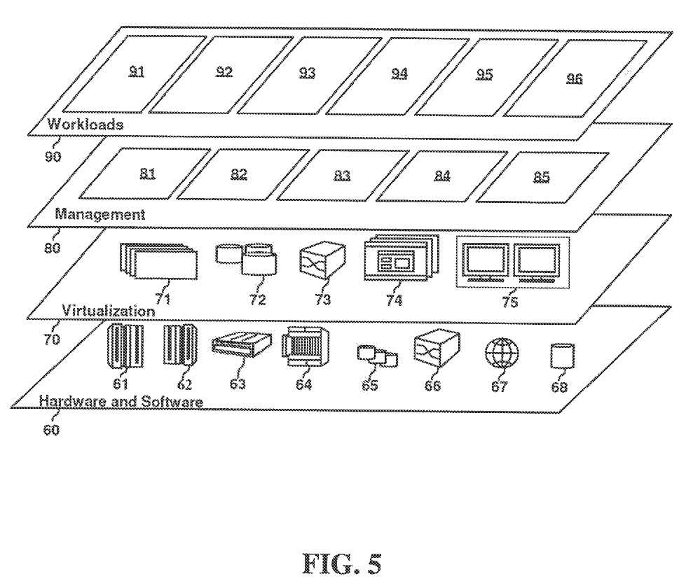

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75. In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources.

In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and event attendance estimating 96, in accordance with the one or more embodiments of the present invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of another feature, step, operation, element, component, and/or group thereof.

At least one embodiment of the present invention may provide a beneficial effect such as, for example, estimating the likely number of attendees in a meeting using one or more machine learning techniques.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
generating one or more event attendance models for individuals, wherein said generating comprises applying one or more machine learning techniques to a set of training data;
computing a probability that each of the individuals will attend a given event by applying one or more of the generated attendance models to (i) an invitation for the given event and (ii) a communication attributed to each of the individuals in response to the invitation;
estimating the number of the individuals that will attend the given event by combining the computed probabilities; and
outputting the estimated number of the individuals that will attend the given event to at least one user.

2. The computer-implemented method of claim 1, wherein the computer-implemented method is provided as a service in a cloud computing environment.

3. The computer-implemented method of claim 1, wherein said generating one or more event attendance models for individuals comprises generating a separate event attendance model for each of the individuals.

4. The computer-implemented method of claim 1, further comprising:
incorporating, into the estimated number of the individuals that will attend the given event, an estimated number of non-invited individuals that will attend the given event.

5. The computer-implemented method of claim 1, further comprising:
revising the estimated number of the individuals that will attend the given event based on the number of reminder messages sent regarding the given event.

6. The computer-implemented method of claim 5, wherein said revising is further based on the proximity to the given event that the reminder messages are sent.

7. The computer-implemented method of claim 1, wherein the training data include event invitation data associated with multiple events.

8. The computer-implemented method of claim 7, wherein the event invitation data include the subject matter of the associated event.

9. The computer-implemented method of claim 7, wherein the event invitation data include the scheduled day and time of the associated event.

10. The computer-implemented method of claim 7, wherein the event invitation data include the duration of the associated event.

11. The computer-implemented method of claim 7, wherein the event invitation data include an identification of one or more of the invited individuals for the associated event.

12. The computer-implemented method of claim 1, wherein the training data include communications attributed to the individuals in response to invitations to one or more events.

13. The computer-implemented method of claim 1, wherein the training data include confirmation of event attendance for one or more previous events.

14. The computer-implemented method of claim 1, wherein the training data include publically-available information regarding the individuals.

15. The computer-implemented method of claim 1, wherein the communication attributed to each of the individuals in response to the invitation includes one of (i) an indication that the individual will attend the given event, (ii) an indication that the individual will not attend the given event, and (iii) an indication that the individual is uncertain about attending the given event.

16. The computer-implemented method of claim 1, further comprising:
allocating one or more resources to the given event based on the estimated number of the individuals that will attend the given event.

17. The computer-implemented method of claim 16, wherein the one or more resources comprises a venue of an appropriate size for holding the given event.

18. The computer-implemented method of claim 1, further comprising:
iteratively changing the scheduled time of the given event to generate multiple proposed scheduled times for the given event;
computing a probability that each of the individuals will attend the given event at each of the multiple proposed scheduled times by applying one or more of the generated attendance models to (i) the invitation for the given event and (ii) a communication attributed to each of the individuals in response to the invitation;
estimating the number of the individuals that will attend the given event at each of the multiple proposed scheduled times by combining the computed probabilities; and
outputting the proposed scheduled time corresponding to the highest estimated number of the individuals that will attend the given event to at least one user.

19. A computer program product comprising a computer readable storage medium having program instructions embodied therewith, the program instructions executable by a device to cause the device to:
generate one or more event attendance models for individuals, wherein said generating comprises applying one or more machine learning techniques to a set of training data;
compute a probability that each of the individuals will attend a given event by applying one or more of the generated attendance models to (i) an invitation for the given event and (ii) a communication attributed to each of the individuals in response to the invitation;
estimate the number of the individuals that will attend the given event by combining the computed probabilities; and
output the estimated number of the individuals that will attend the given event to at least one user.

20. A system comprising:
a memory; and
at least one processor operably coupled to the memory and configured for:
generating one or more event attendance models for individuals, wherein said generating comprises applying one or more machine learning techniques to a set of training data;
computing a probability that each of the individuals will attend a given event by applying one or more of the generated attendance models to (i) an invitation for the given event and (ii) a communication attributed to each of the individuals in response to the invitation;
estimating the number of the individuals that will attend the given event by combining the computed probabilities; and
outputting the estimated number of the individuals that will attend the given event to at least one user.
